(19) United States
(12) Patent Application Publication
(10) Pub. No.: US 2025/0058305 A1
(43) Pub. Date: Feb. 20, 2025

(54) CATALYST COMPRISING A SUPPORT BASED ON SILICO-ALUMINIC MATRIX AND ON ZEOLITE, PREPARATION THEREOF AND PROCESS FOR HYDROCRACKING HYDROCARBON FEEDSTOCKS

(71) Applicant: IFP ENERGIES NOUVELLES, Rueil-Malmaison Cedex (FR)

(72) Inventors: Anne-Claire DUBREUIL, Rueil-Malmaison Cedex (FR); Arnold LAMBERT, Rueil-Malmaison Cedex (FR); Mickael RIVALLAN, Rueil-Malmaison Cedex (FR); Gerhard PIRNGRUBER, Rueil-Malmaison Cedex (FR)

(73) Assignee: IFP ENERGIES NOUVELLES, Rueil-Malmaison Cedex (FR)

(21) Appl. No.: 18/722,379

(22) PCT Filed: Dec. 9, 2022
(86) PCT No.: PCT/EP2022/085090

§ 371 Date: Jun. 20, 2024

(30) Foreign Application Priority Data
Dec. 21, 2021 (FR) FR2114114

(51) Int. Cl. B01J 29/16; B01J 21/12; B01J 35/61; B01J 35/63; B01J 35/64; B01J 37/00; B01J 37/02; B01J 37/08; C10G 47/18

(52) U.S. Cl. CPC B01J 29/166; B01J 21/12; B01J 35/615; B01J 35/633; B01J 35/647; B01J 37/0009; B01J 37/0207; B01J 37/0236; B01J 37/08; C10G 47/18

(57) ABSTRACT

The invention describes a catalyst comprising at least one hydro/dehydrogenating element chosen from the group formed by the elements from group VIB and from group VIII of the periodic table, alone or as a mixture, and a support comprising at least one zeolite and one amorphous silica-alumina, wherein the zeolite has an acid site distribution index (ASDI) of greater than 0.15 and a density of acid sites (determined by H/D exchange) of between 0.05 and 1 mmol/g, and wherein the support has a pore volume, measured by nitrogen porosimetry, developed within the pores with a diameter of between 6 nm and 11 nm, of less than 0.5 ml/g, a grain density, measured by mercury displacement under a pressure of 0.003 MPa, of greater than 0.93 g/ml, and a tapped packing density (TPD) of greater than 0.5 g/ml and less than 0.65 g/ml. A further subject of the present invention relates to the process for preparing said catalyst, comprising at least one step of preparing a silica-alumina gel by mixing a silica precursor with a specific alumina precursor, and to a process for hydrocracking a hydrocarbon feedstock in the presence of said catalyst.

### TECHNICAL FIELD

The present invention relates to a catalyst comprising a support based on a silica-aluminic matrix and on zeolite, and to the hydroconversion processes employing same.

The aim of the process is essentially that of producing middle distillates, i.e. cuts with an initial boiling point of greater than or equal to 150° C. and with a final boiling point of less than the initial boiling point of the residue, for example of less than 350° C., or else of less than 390° C.

### PRIOR ART

The hydrocracking of heavy petroleum cuts is a process frequently used in refining which makes it possible to produce, from surplus and not readily upgradable heavy feedstocks, lighter fractions, such as petrols, jet fuels and light gas oils, which refiners seek in order to adapt their production to the demand structure. Certain hydrocracking processes make it possible to also obtain a highly purified residue that may provide excellent bases for oils. Compared to catalytic cracking, the advantage of catalytic hydrocracking is that of providing middle distillates (jet fuels and gas oils) of very good quality. Conversely, the petrol produced has a much lower octane number than that obtained from catalytic cracking.

Hydrocracking is a process which draws its flexibility from three main elements which are: the operating conditions used, the types of catalysts employed and the fact that the hydrocracking of hydrocarbon feedstocks may be carried out in one step or in two steps.

The higher the catalytic activity of the catalyst, the more efficient the conversion of the feedstock. Thus, a very active catalyst may be used at a lower temperature than a less active catalyst, while maintaining the same level of conversion of the feedstock, which makes it possible to prolong the service life of the catalyst and reduces operating costs. The catalytic activity per unit volume of catalyst is the product of the tapped packing density (TPD, defined below) of said catalyst and its catalytic activity per unit mass. In order to minimize the operating costs associated with the mass of catalyst introduced into a given reactor volume, it is advantageous for said catalyst to have a high catalytic activity per unit mass and a low TPD.

The optimal conversion of the hydrocarbon feedstock is thus the subject of a compromise between high catalytic activity and an optimized TPD.

The TPD of the catalysts is linked to their composition, their porous texture and their geometric shape. The hydrocracking catalysts used in the hydrocracking processes are all of the difunctional type combining an acid function with a hydrogenating function. The acid function is provided by supports having large surface areas that generally range from 100 to 800 m²/g and having a surface acidity, such as halogenated (notably chlorinated or fluorinated) aluminas, combinations of boron and aluminium oxides, amorphous silica-aluminas and zeolites. The hydrogenating function is provided either by one or more metals from group VIII of the periodic table of the elements or by a combination of at least one metal from group VIB of the periodic table and at least one metal from group VIII.

The equilibrium between the two acid and hydrogenating functions is one of the parameters governing the activity and the selectivity of the catalyst. A weak acid function and a strong hydrogenating function afford catalysts that are not very active, operating at a generally elevated temperature (greater than or equal to 390-400° C.), and at a low feed space velocity (HSV expressed in volume of feedstock to be treated per unit of volume of catalyst and per hour is generally less than or equal to 2), but which possess very good selectivity for middle distillates. Conversely, a strong acid function and a weak hydrogenating function afford catalysts that are active but which have worse selectivities for middle distillates.

One type of conventional hydrocracking catalysts is based on moderately acidic amorphous supports, such as for example silica-aluminas. These systems are used to produce good quality middle distillates and, possibly, oil bases. Supports consisting of zeolites in an aluminic matrix are more acidic supports, which also enable the obtaining of middle distillates, but in general with a reduction in the selectivity. “Composite” catalyst supports, consisting of a mixture of highly acidic zeolite(s), for example USY zeolite, and a moderately acidic amorphous matrix, for example a silica-alumina, have intermediate activity and selectivity.

The performance qualities of these catalysts are closely linked with their physicochemical characteristics, and more particularly with their textural characteristics.

The patent FR 2,863,913 describes a hydrocracking catalyst and the use thereof in a hydrocracking process, said catalyst comprising a hydro/dehydrogenating element, a Y zeolite and a silica-alumina matrix, this catalyst having a particular pore distribution with a reduced content of macropores, in particular a pore volume, measured by mercury porosimetry, contained within the pores with a diameter of greater than 500 Å, of less than 0.01 ml/g and a high TPD of the catalyst (greater than 0.85 g/ml).

Patent EP 1,830,959 for its part describes a doped (P, B or Si) hydrocracking catalyst on a support based on zeolite and on aluminosilicate matrix with a reduced content of macropores, with a pore volume, measured by mercury porosimetry, contained within the pores with a diameter of greater than 500 Å, of less than 0.1 ml/g, and the hydrocracking/hydroconversion and hydrotreatment processes employing said catalyst.

Patent application WO2015/164334 describes a hydrocracking catalyst and the use thereof in a hydrocracking process, said catalyst comprising at least one metal chosen from the elements from group 6 and groups 8 to 10 of the periodic table of the elements and a support comprising a molecular sieve and preferably a Y zeolite, an alumina, and a silica-alumina. The nanopore volume of the support developed within the pores with a size of between 6 and 11 nm is between 0.5 and 0.9 ml/g, and the mesopore volume of the support (pores with a size of between 2 and 50 nm) is between 0.7 and 1.2 ml/g. Lastly, the grain density of the support is between 0.7 and 0.9 g/ml. The use of catalyst supports having these characteristics makes it possible to obtain higher activity and a better yield of middle distillates compared to the use of conventional catalyst supports not having these characteristics.

Patent applications WO2016/069071 and WO2016/069073 describe a hydrocracking catalyst and the use thereof in a hydrocracking process, said catalyst comprising a support, an amorphous silica-alumina and a stabilized Y zeolite having an acid site distribution index (ASDI) of between 0.02 and 0.12 and a volume of the macropores in said zeolite representing 15% to 25% of the total pore volume of said zeolite and at least one metal chosen from the elements from group 6 and groups 8 to 10 of the periodic table.

Patent application US2016/0296922 describes a hydrocracking catalyst and the use thereof in a hydrocracking process, said catalyst comprising a support, at least one metal from groups 6 and 8 and at least 10% by weight of a USY zeolite having an acid site density (determined by H/D exchange) of between 0.350 and 0.650 mmol/g, and acid site distribution index (ASDI) of between 0.05 and 0.15, wherein the acid site density and the ASDI are determined by H/D exchange at 80° C. of the acidic hydroxyl groups by FTIR infrared spectroscopy. The use of zeolites having this combination of acidity makes it possible to obtain an improved selectivity for the 121° C.-288° C. cut and an improved activity at 60% conversion.

Lastly, patent application WO2005/084799 describes a support comprising a Y zeolite and an amorphous inorganic oxide, said support having a monomodal pore distribution characterized by the presence of a single narrow peak in the range of mesopores 4-50 nm, a TPD of the support of between 0.35 and 0.50 g/ml, a pore volume developed within the pores with a diameter of between 4 and 50 nm of greater than 0.4 ml/g and representing at least 50% of the total pore volume.

Unexpectedly, the applicant has demonstrated that a catalyst support having a specific porosity, said support comprising at least one silica-alumina and said zeolite, results in catalytic performance qualities that are improved in terms of selectivity for middle distillates when it is used in a hydrocracking process, compared to the prior art catalysts. In particular, the specific porosity of said support results from the process for preparing said silica-alumina, and very particularly from the characteristics of the alumina precursor used in the synthesis of the silica-alumina gel.

In a preferred embodiment, the applicant has demonstrated that the use of a zeolite having a particular acidity in a catalyst support having a specific porosity, said support comprising at least one silica-alumina and said zeolite, results in catalytic performance qualities that are improved not only in terms of selectivity for middle distillates but also in terms of activity when it is used in a hydrocracking process, compared to the prior art catalysts.

### DESCRIPTION OF THE INVENTION

### Characterization Techniques

In what follows, the groups of chemical elements are given according to the CAS classification (CRC Handbook of Chemistry and Physics, published by CRC Press, editor-in-chief D. R. Lide, 81st edition, 2000-2001). For example, group VIII according to the CAS classification corresponds to the metals of columns 8, 9 and 10 according to the new IUPAC classification.

The various atomic contents in the zeolites, the alumina precursors, the supports of the catalysts are measured by X-ray fluorescence, by atomic absorption spectrometry or by inductively coupled plasma (ICP) spectrometry, using the method most suitable for the value measured.

In the present description, according to the IUPAC convention, the term “micropores” is understood to mean the pores, the diameter of which is less than 2 nm; “mesopores” the pores, the diameter of which is greater than 2 nm and less than 50 nm, and “macropores” the pores, the diameter of which is greater than or equal to 50 nm.

The term “specific surface area” of the zeolites, supports or catalysts means the BET specific surface area determined by nitrogen adsorption in accordance with the standard ASTM D 3663-78 established from the Brunauer-Emmett-Teller method described in the journal The Journal of the American Chemical Society, 60, 309 (1938).

The pore distribution measured by nitrogen adsorption was determined by the Barrett-Joyner-Halenda (BJH) model. The nitrogen adsorption-desorption isotherm according to the BJH model is described in The Journal of the American Chemical Society, 73, 373 (1951), by E. P. Barrett, L. G. Joyner and P. P. Halenda. In the following disclosure of the invention, the term “nitrogen pore volume” (N2 Vpore) is understood to mean the volume measured by nitrogen adsorption for P/P0=0.99, the pressure at which it is accepted that nitrogen has filled all of the pores.

The quantitative analysis of the microporosity (pores with a diameter of less than 2 nm) is performed by means of the “t” method (Lippens-De Boer method, 1965), which corresponds to a transform of the starting nitrogen adsorption isotherm, as described in the publication “Adsorption by Powders and Porous Solids. Principles, Methodology and Applications”, written by F. Rouquerol, J. Rouquerol and K. Sing, Academic Press, 1999.

The “mercury pore volume” (Hg Vpore) of the supports and catalysts is understood to mean the volume measured by mercury intrusion porosimetry according to the standard ASTM D4284-83 at a maximum pressure of 4000 bar (400 MPa), using a surface tension of 485 dynes/cm and a contact angle of 140°. The wetting angle was taken equal to 140° following the recommendations of the publication “Techniques de l′ingénieur, traité analyse et caractérisation” [Techniques of the Engineer, Analysis and Characterization Treatise], pages 1050-1055, written by Jean Charpin and Bernard Rasneur. The value at and above which the mercury fills all the intergranular voids is set at 0.2 MPa and it is considered that, above this value, the mercury penetrates into the pores of the sample. In order to obtain better accuracy, the value of the pore volume corresponds to the value of the pore volume measured by mercury intrusion porosimetry measured on the sample minus the value of the pore volume measured by mercury intrusion porosimetry measured on the same sample for a pressure corresponding to 0.2 MPa.

The mean diameter (mean D (Hg)) is defined as being a diameter such that all the pores of a size less than this diameter constitute 50% of the mercury pore volume (Hg Vpore), within a range between 36 Å and 1000 Å.

To describe the pore distributions measured by nitrogen adsorption or by mercury porosimetry, V (<x nm) and V (>x nm) define the volume developed within the pores with a diameter of less than or, respectively, greater than x nm. V (x-y nm) defines the volume developed within the pores with a diameter of between x nm and y nm.

In order to better characterize the pore distribution, the following pore distribution criteria are defined, measured by mercury porosimetry:
The volume V1 corresponds to the volume contained within the pores the diameter of which is less than the mean diameter minus 3 nm.
The volume V2 corresponds to the volume contained within the pores with a diameter of greater than or equal to the mean diameter minus 3 nm and less than the mean diameter plus 3 nm.
The volume V3 corresponds to the volume contained within the pores with a diameter of greater than or equal to the mean diameter plus 3 nm.
The volume V4 corresponds to the volume contained within the pores the diameter of which is less than the mean diameter minus 1.5 nm.
The volume V5 corresponds to the volume contained within the pores with a diameter of greater than or equal to the mean diameter minus 1.5 nm and less than the mean diameter plus 1.5 nm.
The volume V6 corresponds to the volume contained within the pores with a diameter of greater than or equal to the mean diameter plus 1.5 nm.

The grain density is obtained by the formula gd=M/V, with M being the mass and V being the volume of the sample. This volume V of the sample is determined by measuring the volume displaced when the sample is immersed into mercury under a pressure of 0.003 MPa.

The tapped packing density (TPD) of the supports and of the catalysts is measured as described in the work “Applied Heterogeneous Catalysis” by J. F. Le Page et al., Technip, Paris, 1987. A graduated cylinder with acceptable dimensions is filled by successive additions and, between each addition, the catalyst is tapped by shaking the cylinder until a constant volume is achieved. This measurement is generally carried out on 1000 ml of tapped catalyst in a cylinder having a height-to-diameter ratio of close to 5:1. This measurement may, preferably, be carried out on automated instruments such as the Autotap® instrument sold by Quantachrome®.

The dispersibility index of the boehmite gel is defined as the percentage by weight of peptized alumina gel that can be dispersed by centrifugation in a polypropylene tube at 3600G for 10 min. The dispersibility is measured by dispersing 10% boehmite in a suspension of water also containing 10% nitric acid relative to the mass of boehmite. The suspension is then centrifuged at 3600G rpm for 10 min. The sediments recovered are dried overnight at 100° C. and then weighed. The dispersibility index, denoted DI, is obtained by the following calculation: DI (%)=100%-mass of dried sediments (%).

The dimensions of the crystallites of the boehmite gels are measured by X-ray diffraction using a PANalytical X'Pert Pro diffractometer operating in reflection and equipped with a rear monochromator using CuKalpha radiation (AKa1=1.5406 Å, AKa2=1.5444 Å). The dimensions of the crystallites are measured along two crystallographic directions [020] and [120] using the Scherrer formula described in the reference “Scherrer after sixty years: A survey and some new results in the determination of crystallite size”, J. I. Langford and A. J. C. Wilson, Appl. Cryst., 11, 102-113 (1978).

The lattice parameter a0 of the unit cell of the zeolite, or lattice constant, is measured by X-ray diffraction in accordance with the standard ASTM 03942-80.

The Brønsted acidity of the zeolites is measured by adsorption and consecutive thermodesorption of pyridine followed by infrared (FTIR) spectroscopy. This method is conventionally used to characterize acidic solids such as zeolites, as described in the journal C. A. Emeis, Journal of Catalysis, 141, 347 (1993). Before analysis, the zeolite powder is compacted in the form of a pellet 16 mm in diameter and is activated under secondary vacuum at 450° C. The introduction of the pyridine in gas phase in contact with the activated pellet and the thermodesorption step are carried out at 150° C. The concentration of pyridinium ion detected by FTIR after thermodesorption at 150° C. corresponds to the Brønsted acidity of the zeolite and is expressed in micromol/g of zeolite.

The distribution of the Brønsted acid sites and the acid site distribution index (ASDI) are determined by H/D exchange followed by IR spectroscopy according to the method described in the journal E. J. M. Hensen et al., J. Phys. Chem. C, 114, 8363-8374 (2010). Before the IR measurement, the sample is thermally activated at 400-450° C. under vacuum (<1×10−5 Torr) for 1 hour. The sample is then assayed by introducing deuterated benzene into contact (equilibrium) at 80° C. An IR spectrum is recorded before and after contact to analyse the region of the hydroxyls (OH)/deuteroxyls (OD).

The density of Brønsted acid sites is determined by integrating the areas of the contributions centred at 2676 cm 1 (1st high frequency OD (HF), 2653 cm 1 (2nd high frequency OD (HF′), 2632 and 2620 cm 1 (1st low frequency OD (BF), 2600 cm 1 (2nd low frequency OD (BF′). The density of the Brønsted acid sites is expressed in mmol/g of zeolite. The acid site distribution index (ASDI) expresses the content of hyperactive acid sites present in the zeolite and is determined as follows:

$$ASDI = ( {HF}^{′} + {LF}^{′} ) / ( HF + LF )$$

In the remainder of the text, the acid site distribution and the acid site density relate to the Brønsted acid sites even if this is not explicitly stated.

In the remainder of the text, the expressions “of between . . . and . . . ” and “between . . . and . . . ” are equivalent and mean that the limit values of the interval are included in the described range of values. If such were not the case and if the limit values were not included in the described range, such a clarification will be given by the present invention.

For the purposes of the present invention, the various ranges of parameters for a given step, such as the pressure ranges and the temperature ranges, may be used alone or in combination. For example, for the purposes of the present invention, a preferred range of pressure values can be combined with a range of more preferred temperature values.

### SUMMARY OF THE INVENTION

One subject of the present invention is a catalyst comprising at least one hydro/dehydrogenating element chosen from the group formed by the elements from group VIB and from group VIII of the periodic table, alone or as a mixture, and a support comprising at least one zeolite and one amorphous silica-alumina, wherein the support has:
a pore volume, measured by nitrogen porosimetry, developed within the pores with a diameter of between 6 nm and 11 nm, of less than 0.5 ml/g,
a grain density, measured by mercury displacement under a pressure of 0.003 MPa, of greater than 0.93 g/ml,
a tapped packing density (TPD) of greater than 0.5 g/ml and less than 0.65 g/ml.

A further subject of the present invention relates to the process for preparing said catalyst, comprising at least one specific step of preparing a silica-alumina gel by mixing a silica precursor with an alumina precursor having specific characteristics and in particular having:
a dispersibility index of between 15% and 70%,
a sodium content of between 0.003% and 2% by weight, relative to the total mass of the alumina precursor,
a sulfur content of between 0.005% and 2% by weight, relative to the total mass of the alumina precursor,
followed by a step of mixing said silica-alumina gel with a zeolite having specific characteristics.

Another subject of the present invention is a process for hydrocracking a hydrocarbon feedstock in the presence of said catalyst.

One advantage of the present invention is that of providing a catalyst that makes it possible to obtain a better activity and a better selectivity for middle distillates when it is used in a process for hydrocracking hydrocarbon feedstocks, compared to the use of a prior art catalyst not having these characteristics.

### DETAILED DESCRIPTION OF THE INVENTION

The catalyst according to the invention comprises at least one hydro/dehydrogenating element chosen from the group formed by the elements from group VIB and from group VIII of the periodic table, alone or as a mixture.

Preferably, the element from group VIII is chosen from iron, cobalt, nickel, taken alone or as a mixture, preferably from nickel and cobalt, and very preferably nickel.

Preferably, the element from group VIB is chosen from tungsten and molybdenum, taken alone or as a mixture, and preferably tungsten.

Preferably, the catalyst according to the invention comprises an active phase comprising, preferably consisting of, at least one metal from group VIB, preferably tungsten, and at least one metal from group VIII, and preferably nickel.

The following combinations of metals are preferred: nickel-molybdenum, cobalt-molybdenum, nickel-tungsten, cobalt-tungsten, and very preferably: nickel-tungsten. It is also possible to use combinations of three metals, such as for example nickel-cobalt-molybdenum.

The content in the catalyst of element from group VIII is advantageously between 0.03% and 15% by weight of oxide relative to the total weight of said catalyst, preferably between 0.5% and 10% by weight of oxide and very preferably between 1.0% and 8% by weight of oxide.

The content in the catalyst of element from group VIB is advantageously between 1% and 50% by weight of oxide relative to the total weight of said catalyst, preferably between 5% and 40% by weight of oxide, and more preferably still between 10% and 35% by weight of oxide.

The catalyst according to the invention may optionally comprise at least one doping element deposited on the catalyst and chosen from the group formed by phosphorus, boron and silicon. In this case, the contents by mass of boron, silicon and phosphorus in the form of oxides are between 0% and 15%, preferably between 0% and 10%, and more advantageously still between 0% and 5% by weight.

More preferably still, the catalyst does not contain this type of doping element.

The catalyst according to the invention may also optionally comprise at least one element from group VIIB, preferably manganese. In this case, the content by weight of element from group VIIB is preferably between 0.005% and 20%, preferably between 0.5% and 10%, of the compound in oxide or metal form.

The catalyst according to the invention may also optionally comprise at least one element from group VB, preferably niobium. In this case, the content by weight of element from group VIIB is preferably between 0.005% and 40%, preferably between 0.5% and 20%, of the compound in oxide or metal form.

### The Support

The catalyst according to the invention comprises a support which comprises at least one zeolite and at least one amorphous silica-alumina.

Preferably, said support consists of at least one zeolite, at least one amorphous silica-alumina and optionally a binder.

The zeolite used in the support of the catalyst according to the invention is chosen from Y, USY, VUSY, SDUSY, mordenite, beta, EU-1, EU-2, EU-11, Nu-87, ZSM-48 or ZBM-30 zeolites, and preferably from Y, ultrastable Y(USY), very ultrastable Y(VUSY), or dealuminated ultrastable Y(SDUSY) zeolites and beta zeolite, alone or as a mixture. Very preferably, the zeolite is chosen from Y, ultrastable Y(USY), very ultrastable Y(VUSY) and dealuminated ultrastable Y(SDUSY) zeolites.

These designations, USY, VUSY and SDUSY, are common in the literature but do not restrict the characteristics of the zeolites of the present invention to such a designation.

Said zeolites are advantageously defined in the classification “Atlas of Zeolite Framework Types, 6th revised edition”, Ch. Baerlocher, L. B. McCusker, D. H. Olson, 6th Edition, Elsevier, 2007, Elsevier.

Preferably, said zeolite has an acid site distribution index (ASDI) measured by H/D exchange of greater than 0.15, and preferably of less than 0.4, preferably of greater than 0.17, with preference greater than 0.19, very preferably of between 0.20 and 0.35 and more preferably still of between 0.20 and 0.28.

Preferably, said zeolite has an acid site density (measured by H/D exchange) of between 0.05 and 1 mmol/g, preferably of between 0.3 and 0.8 mmol/g, with preference of between 0.35 and 0.65 mmol/g and very preferably of between 0.5 and 0.6 mmol/g.

Preferably, said zeolite has an acidity, measured by monitoring by infrared the thermodesorption of pyridine, of greater than 100 micromol/g, preferably of greater than 150 micromol/g, with preference of between 160 and 800 micromol/g, more preferably of between 180 and 400 micromol/g and more preferably still of between 190 and 350 micromol/g.

Preferably, the zeolite used in the catalyst support according to the invention has:
an overall SiO₂/Al₂O₃ molar ratio of greater than 8, preferably between approximately 10 and 150, with preference of between 12 and 120, and more preferably still of between 20 and 80,
a content of alkali or alkaline earth metal cations and/or of rare earth cations, and preferably a content of sodium, determined on the zeolite calcined at 1100° C., of less than 0.2% by weight, preferably of less than 0.1% by weight and with preference of less than 0.05% by weight,
a lattice parameter a0 of the unit cell of between 24.10×10¹⁰ and 24.45×10¹⁰ m, preferably of between 24.15×10¹⁰ and 24.40×10¹⁰ m, with preference of between 24.20×10¹⁰ and 24.38×10¹⁰ m and more preferably still of between 24.2410¹⁰ and 24.35×10¹⁰ m,
a specific surface area, determined by the BET method, of greater than 400 m²/g, preferably of greater than 550 m²/g, with preference of greater than 700 m²/g and more preferably still of greater than 850 m²/g,
a total pore volume, determined by nitrogen physisorption at P/P0=0.99, of less than 0.2 ml/g, preferably of between 0.3 and 0.7 ml/g and with preference of between 0.5 and 0.65 ml/g,
a volume developed within the pores with a diameter of less than 2 nm and measured by nitrogen physisorption which represents between 20% and 95%, preferably between 40% and 80%, and with preference between 50% and 65%, of the total pore volume,
a volume developed within the pores with a diameter of greater than 2 nm and less than 50 nm and measured by nitrogen physisorption which represents at least 5%, preferably at least 10%, with preference between 15% and 70%, and more preferably still between 20% and 50%, of the total pore volume,
a volume developed within the pores with a diameter of greater than 8 nm and measured by nitrogen physisorption which represents at least 0.1% and preferably at least 1%, and more preferably still at least 5%, of the total pore volume,
a volume developed within the pores with a diameter of greater than 50 nm, and measured by nitrogen physisorption, which represents less than 15% and preferably less than 10% of the total pore volume. In a very preferred embodiment, the zeolite is devoid of macropores.

Said characteristics of the zeolite are the characteristics of the zeolite as used in the synthesis of the support of the catalyst according to the invention.

In the case where the zeolite is a Y, USY, VUSY or SDUSY zeolite, the zeolite used in the catalyst support having the particular characteristics defined above is advantageously prepared from a Y zeolite preferably having an overall Si/Al atomic ratio after synthesis of between 2.3 and 2.8 and advantageously being in NaY form after synthesis. Said Y zeolite advantageously undergoes one or more ion exchange steps before undergoing one or more dealumination steps. The ion exchange(s) make it possible to partially or totally replace the alkaline cations belonging to groups IA and IIA of the periodic table present in cationic position in the crude synthesis Y zeolite with NH₄⁺ cations, and preferably Na⁺ cations with NH₄⁺ cations.

Partial or total exchange of the alkaline cations by NH₄⁺ cations is understood to mean the exchange of from 80% to 100%, preferably from 85% to 99.5% and more preferably from 88% to 99%, of said alkaline cations with NH₄⁺ cations. At the end of the ion exchange step(s), the remaining amount of alkaline cations, and preferably the remaining amount of Na⁺ cations, in the Y zeolite, relative to the amount of alkaline cations, preferably Na⁺ cations, initially present in the Y zeolite, is advantageously between 0% and 20%, preferably between 0.5% and 15%, and with preference between 1.0% and 12%.

Preferably, this step implements a plurality of ion exchanges with a solution containing at least one ammonium salt chosen from chlorate, sulfate, nitrate, phosphate or acetate salts of ammonium, so as to at least partially remove the alkaline cations, and preferably the Na⁺ cations, present in the zeolite. Preferably, the ammonium salt is ammonium nitrate NH₄NO₃.

The alkaline cation/aluminium ratio, preferably Na/Al ratio, desired is obtained by adjusting the NH₄⁺ concentration of the ion exchange solution, the ion exchange temperature and the number of ion exchanges. The NH₄⁺ concentration of the ion exchange solution advantageously varies between 0.01 and 12 mol.I¹, and preferably between 1.00 and 10 mol.I 1. The temperature of the ion exchange step is advantageously between 2° and 100° C., preferably between 6° and 95° C., with preference between 6° and 90° C., more preferably between 6° and 85° C., and more preferably still between 6° and 80° C. The number of ion exchanges advantageously varies between 1 and 10, and preferably between 1 and 4.

Said Y zeolite obtained may then undergo one or more dealumination treatment steps. Said dealumination step(s) may advantageously be carried out by any of the methods known to those skilled in the art. Preferably, the dealumination is carried out by a heat treatment optionally in the presence of water vapour (or “steaming”) and/or by one or more acid attacks advantageously carried out by treatment with an aqueous mineral or organic acid solution.

Preferably, the dealumination step implements a heat treatment followed by one or more acid attacks, or just one or more acid attacks.

Preferably, the heat treatment optionally in the presence of steam, to which said Y zeolite is subjected, is carried out at a temperature of between 20° and 900° C., preferably between 30° and 900° C., more preferably still between 40° and 750° C. The duration of said heat treatment is advantageously greater than or equal to 0.5 hours, preferably between 0.5 hours and 24 hours, and very preferably between 1 hour and 12 hours. In the case where the heat treatment is carried out in the presence of water, the percentage by volume of steam during the heat treatment is advantageously between 5% and 100%, preferably between 20% and 100%, and very preferably between 40% and 100%. Any volume fraction present that is not steam is formed of air. The flow rate of gas formed of steam and possibly air is advantageously between 0.2 I.h⁻¹.g⁻¹ and 10 I.h⁻¹.g⁻¹ of Y zeolite.

The heat treatment enables the extraction of aluminium atoms from the structure of the Y zeolite while keeping the overall Si/Al atomic ratio of the treated zeolite unchanged.

The step of heat treatment in the presence of steam may advantageously be repeated as many times as is necessary to obtain the Y zeolite suitable for implementing the support of the catalyst used in the process according to the invention and having the characteristics as claimed.

The step of heat treatment optionally in the presence of steam is advantageously followed by an acid attack step. Said acid attack makes it possible to partially or completely remove the aluminic debris resulting from the step of heat treatment in the presence of steam which may partially block the porosity of the dealuminated zeolite; the acid attack thus makes it possible to unblock the porosity of the dealuminated zeolite.

The acid attack may advantageously be carried out by suspending the Y zeolite, which has optionally undergone a heat treatment beforehand, in an aqueous solution containing a mineral or organic acid. The mineral acid may be nitric acid, sulfuric acid, hydrochloric acid, phosphoric acid or boric acid. The organic acid may be formic acid, acetic acid, oxalic acid, tartaric acid, maleic acid, malonic acid, malic acid, lactic acid, or any other water-soluble organic acid. The mineral or organic acid concentration in the solution advantageously varies between 0.01 and 2.0 mol.I¹, and preferably between 0.5 and 1.0 mol.I¹. The temperature of the acid attack step is advantageously between 2° and 100° C., preferably between 6° and 95° C., with preference between 6° and 90° C. and more preferably between 6° and 80° C. The duration of the acid attack is advantageously between 5 minutes and 8 hours, preferably between 30 minutes and 4 hours, and with preference between 1 hour and 2 hours.

On conclusion of the step(s) of heat treatment optionally in the presence of steam and optionally of the acid attack step, the process for modifying said Y zeolite advantageously includes a step of at least partial or complete exchange of the alkaline cations, and preferably the Na⁺ cations, still present in cationic position in the Y zeolite. The ion exchange step is carried out in a similar manner to the ion exchange step described above.

On conclusion of the step(s) of heat treatment optionally in the presence of steam and optionally of the acid attack step and optionally of the step of partial or complete exchange of the alkaline cations and preferably Na⁺ cations, the process for modifying said Y zeolite may include a calcination step. Said calcination makes it possible to remove the organic species present within the porosity of the zeolite, for example those supplied by the acid attack step or by the step of partial or complete exchange of the alkaline cations. In addition, said calcination step makes it possible to generate the protonated form of the Y zeolite and to impart upon it an acidity for the purposes of the applications thereof.

The calcination may advantageously be carried out in a muffle furnace or in a tubular furnace, under dry air or under inert atmosphere, in a swept bed or a traversed bed. The calcination temperature is advantageously between 20° and 800° C., preferably between 45° and 600° C., and with preference between 50° and 550° C. The duration of the calcination hold is advantageously between 1 and 20 hours, preferably between 6 and 15 hours, and with preference between 8 and 12 hours.

Thus, said Y, and preferably USY, zeolite obtained advantageously has an acid site distribution index (ASDI) of greater than 0.15 and an acid site density (determined by H/D exchange) of between 0.05 and 1 mmol/g and the characteristics defined above.

Preferably, the content by weight of zeolite in the support is generally between 0.1% and 60% by weight relative to the total weight of said support, preferably between 1% and 30% by weight, with preference between 2% and 15% by weight, more preferably between 3% and 12% by weight and more preferably still between 4% and 10% by weight.

According to the invention, the support also comprises an amorphous silica-alumina.

The content by weight of silica-alumina in the support is preferably between 1% and 99.9% by weight relative to the total weight of said support, preferably between 20% and 98% by weight, and with preference between 40% and 96% by weight.

The content by mass of silica (SiO₂) in the silica-alumina is between 5% and 95% by weight, preferably between 10% and 70% by weight, with preference between 15% and 60% by weight, more preferably still between 20% and 50% by weight.

In accordance with the process for preparing the catalyst according to the invention, said amorphous silica-alumina is obtained by reaction of a silicic precursor with a specific aluminic precursor having the claimed characteristics and according to the preparation method detailed below, which describes the obtaining of a silica-alumina gel, the shaping thereof with the zeolite and the heat and hydrothermal treatments that make it possible to arrive at the characteristics of the support described above.

In accordance with the invention, the support has:
a pore volume, measured by nitrogen physisorption, contained within the pores with a diameter of between 6 nm and 11 nm, of less than 0.5 ml/g,
a grain density, measured by mercury displacement under a pressure of 0.003 MPa, of greater than 0.93 g/ml,
a tapped packing density (TPD) of greater than 0.5 g/ml and less than 0.65 g/ml.

With preference, the support has a pore volume, measured by nitrogen physisorption, contained within the pores with a diameter of greater than 6 nm and less than 11 nm, of between 0.05 and 0.45 ml/g and preferably of between 0.1 and 0.35 ml/g.

Preferably, the support has a grain density, measured by mercury displacement under a pressure of 0.003 MPa, of between 0.95 and 1.5 g/ml and with preference of between 0.96 and 1.2 g/ml.

Preferably, the support has a tapped packing density (TPD) of between 0.53 and 0.62 g/ml.

Said support of the catalyst according to the invention also advantageously has the following characteristics:
a specific surface area, determined by the BET method, of between 100 and 600 m²/g, preferably of between 150 and 450 m²/g, and more preferably still of between 250 and 400 m²/g,
a total pore volume, measured by nitrogen porosimetry, of greater than 0.45 ml/g, preferably of between 0.5 and 1 ml/g and more preferably still of between 0.6 and 0.7 ml/g,
   such that the volume developed within the pores with a diameter of greater than 2 nm and less than 50 nm and measured by nitrogen physisorption represents less than 99.9%, preferably between 40% and 99.5%, and with preference between 80% and 99%, of the total pore volume,
   and such that the volume developed within the pores with a diameter of less than 2 nm and measured by nitrogen physisorption represents at least 0.1%, preferably between 0.2% and 50%, with preference between 0.5% and 30%, and more preferably still between 0.8% and 15%, of the total pore volume,
a total pore volume, measured by mercury porosimetry, of greater than 0.45 ml/g, preferably of between 0.5 and 1 ml/g and more preferably still of between 0.5 and 0.75 ml/g,
a pore volume, measured by mercury porosimetry, contained within the pores with a diameter of greater than 14 nm, of less than 0.35 ml/g and preferably of less than 0.25 ml/g,
a pore volume, measured by mercury porosimetry, contained within the pores with a diameter of greater than 16 nm, of less than 0.3 ml/g and preferably of less than 0.2 ml/g,
a pore volume, measured by mercury porosimetry, contained within the pores with a diameter of greater than 20 nm, of less than 0.15 ml/g and preferably of less than 0.1 ml/g,
a pore volume, measured by mercury porosimetry, contained within the pores with a diameter of greater than 50 nm, of less than 0.01 ml/g, preferably of less than 0.005 ml/g, and with preference this volume is zero,
a multimodal pore size distribution, measured by mercury porosimetry, in the domain of the pores having a diameter of between 4 and 50 nm, that is to say having at least 2 distinct peaks or one broad peak with one or more shoulders having a mean pore diameter of between 4 and 50 nm, preferably between 5 and 20 nm and more preferably still between 6 and 16 nm,
a ratio of the volume V2, defined above, to the total pore volume, these two volumes being measured by mercury porosimetry, of less than 0.8, preferably of less than 0.7 and more preferably still of between 0.2 and 0.6,
preferably a volume V3, defined above, of greater than 0.05 ml/g, with preference of greater than 0.06 ml/g and more preferably still of between 0.07 and 0.35 ml/g,
a ratio between the volume V5 and the volume V2, defined above, of less than 0.8, preferably of less than 0.7 and more preferably still of between 0.2 and 0.6,
preferably a volume V6, defined above, of greater than 0.05 ml/g, with preference of greater than 0.1 ml/g and more preferably still of between 0.15 and 0.5 ml/g.

The support may also optionally comprise a binder.

Said binder advantageously consists of at least one refractory oxide, preferably chosen from the group formed by alumina, silica-alumina, clay, titanium oxide, boron oxide and zirconia, taken alone or as a mixture. Preferably, the binder is alumina. The alumina can advantageously be in any of its forms known to those skilled in the art. Very preferably, the alumina is chosen from the group made up of alpha, rho, chi, kappa, eta, gamma, theta and delta aluminas, and with preference chosen from gamma, theta and delta aluminas. In the case where said support comprises alumina, the content by weight of alumina in the support of the catalyst according to the invention is preferably between 1% and 70% by weight relative to the total weight of said support, preferably between 2% and 60% by weight, and more preferably still between 5% and 50% by weight.

### Characteristics of the Catalyst

Said catalyst according to the invention advantageously has the following characteristics:
a TPD of between 0.5 and 1.5 g/ml, preferably of between 0.55 and 1.2 g/ml, more preferably still of between 0.65 and 1 g/ml and more preferably still of between 0.7 and 0.85 g/ml,
a specific surface area, determined by the BET method, of less than 600 m²/g, preferably of between 50 and 450 m²/g, and more preferably still of between 170 and 350 m²/g,
a total pore volume, measured by nitrogen porosimetry, of greater than 0.2 ml/g, preferably of between 0.25 and 0.80 ml/g and more preferably still of between 0.35 and 0.55 ml/g,
a total pore volume, measured by mercury porosimetry, of greater than 0.2 ml/g, preferably of between 0.25 and 0.75 ml/g and more preferably still of between 0.3 and 0.55 ml/g,
a multimodal pore size distribution, measured by mercury porosimetry, in the domain of the pores having a diameter of between 4 and 50 nm, that is to say having at least 2 distinct peaks or one broad peak with one or more shoulders having a mean pore diameter of between 4 and 50 nm, preferably between 5 and 20 nm and more preferably still between 6 and 16 nm,
a ratio of the volume V2, defined above, to the total pore volume, these two volumes being measured by mercury porosimetry, of less than 0.8, preferably of less than 0.6 and more preferably still of between 0.2 and 0.55,
preferably a volume V3, defined above, of greater than 0.04 ml/g, with preference of between 0.05 and 0.45 ml/g and more preferably still of between 0.1 and 0.25 ml/g,
a ratio between the volume V5 and the volume V2, defined above, of less than 0.8, preferably of less than 0.6 and more preferably still of between 0.2 and 0.55,
preferably a volume V6, defined above, of greater than 0.05 ml/g, with preference of greater than 0.1 ml/g and more preferably still of between 0.1 and 0.4 ml/g,
preferably a pore volume, measured by mercury porosimetry, contained within the pores with a diameter of greater than 14 nm, of less than 0.3 ml/g and preferably of less than 0.2 ml/g,
preferably a pore volume, measured by mercury porosimetry, contained within the pores with a diameter of greater than 16 nm, of less than 0.25 ml/g and preferably of less than 0.15 ml/g,
preferably a pore volume, measured by mercury porosimetry, contained within the pores with a diameter of greater than 20 nm, of less than 0.15 ml/g and preferably of less than 0.1 ml/g,
a pore volume, measured by mercury porosimetry, contained within the pores with a diameter of greater than 50 nm, of less than 0.005 ml/g, preferably of less than 0.003 ml/g, and with preference this volume is zero,
a ratio of the pore volume contained within the pores with a diameter of greater than 50 nm to the total pore volume, these two volumes being measured by mercury porosimetry, of less than 2%, preferably of less than 1% and with preference this ratio is zero,
a ratio of the pore volume contained within the pores with a diameter of greater than 8 nm and less than 20 nm to the total pore volume, these two volumes being measured by mercury porosimetry, of greater than 35%, preferably of between 40% and 90% and more preferably still of between 55% and 75%,
a ratio of the pore volume contained within the pores with a diameter of greater than 20 nm and less than 50 nm to the total pore volume, these two volumes being measured by mercury porosimetry, of less than 35%, preferably of less than 25% and more preferably still of less than 20%.

The content by weight of support in the catalyst is generally greater than 5% relative to the total weight of said catalyst, advantageously greater than 15% by weight, preferably between 40% and 95% by weight and more preferably still between 65% and 90% by weight.

The content by weight of silica-alumina in the catalyst is generally between 1% and 99% relative to the total weight of said catalyst, advantageously between 10% and 85% by weight, and preferably between 40% and 75% by weight.

In the case where said support comprises an aluminic binder, the content by weight of alumina in the catalyst is generally between 0.5% and 70% relative to the total weight of said catalyst, advantageously between 1% and 60% by weight, and preferably between 3% and 50% by weight.

The content by weight of zeolite in the catalyst is generally between 0.1% and 30% relative to the total weight of said catalyst, advantageously between 0.2% and 20% by weight, preferably between 0.5% and 10% by weight, more preferably between 1% and 9% by weight and more preferably still between 1.5% and 8% by weight.

### Preparation Methods

Another subject of the invention is the process for preparing the catalyst according to the invention.

In particular, another subject of the invention is the process for preparing the catalyst according to the invention, comprising at least the following steps:
a) a step of preparing a silica-alumina gel by mixing a silica precursor with an alumina precursor, said alumina precursor having:
   a dispersibility index of between 15% and 70%,
   a sodium content of between 0.003% and 2% by weight, relative to the total mass of the alumina precursor,
   a sulfur content of between 0.005% and 2% by weight, relative to the total mass of the alumina precursor,
b) a step of mixing at least one zeolite with the silica-alumina gel, said zeolite having an acid site distribution index (ASDI) measured by H/D exchange of greater than 0.15,
c) a step of shaping, optionally in the presence of an aluminic binder, of the mixture obtained,
d) at least one step of drying the shaped material,
e) at least one step of heat and/or hydrothermal treatment of the dried material to obtain the support,
f) a step of introducing onto the support at least one hydro/dehydrogenating element chosen from the group formed by the elements from group VIB of the periodic table and the non-noble elements from group VIII of the periodic table,
g) at least one step of drying the impregnated support,
e) and optionally at least one step of heat and/or hydrothermal treatment of the impregnated and dried support to obtain said catalyst.

The properties of the support described above correspond to the support obtained on conclusion of step e).

The properties of the catalyst described above correspond to the catalyst obtained on conclusion of steps g) and optionally h) in the case where step h) is carried out.

### Step a)

In accordance with the invention, said process comprises a step a) of preparing a silica-alumina gel by mixing a silica precursor with an alumina precursor, said alumina precursor having:
a dispersibility index of between 15% and 70%, preferably of between 30% and 70%, and more preferably still of between 50% and 68%,
a sodium content of between 0.003% and 2% by weight, relative to the total mass of the alumina precursor, preferably of between 0.005% and 1% by weight, and more preferably still of between 0.006% and 0.1% by weight, relative to the total mass of the alumina precursor,
a sulfur content of between 0.005% and 2% by weight, relative to the total mass of the alumina precursor, preferably of between 0.01% and 1% by weight, and more preferably still of between 0.02% and 0.2% by weight, relative to the total mass of the alumina precursor.

The use of an alumina precursor having the characteristics as claimed in step a of preparing said silica-alumina gel makes it possible to obtain the specific porosity of said support.

Preferably, said alumina precursor is composed of crystallites the size of which, obtained by the Scherrer formula in X-ray diffraction along the crystallographic directions and [120], is respectively between 2 and 20 nm and between 2 and 35 nm. Preferably, the alumina precursor has a crystallite size along the crystallographic direction of between 2 and 15 nm and a crystallite size along the crystallographic direction of between 2 and 30 nm.

The alumina precursor may advantageously be chosen from the group of hydrated alumina compounds of general formula Al₂O₃·nH₂O. It is in particular possible to use aluminium hydrates such as hydrargillite, gibbsite, bayerite, boehmite, pseudo-boehmite and amorphous or essentially amorphous alumina gels. The aluminium hydrate Al₂O₃·nH₂O used more preferentially is boehmite.

Said alumina precursor may advantageously be prepared according to any of the methods known to those skilled in the art. Depending on the acidic or basic nature of the initial aluminium-based compound, the aluminium hydrate is precipitated using a base or an acid, chosen for example from hydrochloric acid, sulfuric acid, sodium hydroxide or a basic or acidic compound of aluminium as mentioned above. The two reactants may be aluminium sulfate and sodium aluminate. For an example of the preparation of alpha-alumina monohydrate using aluminium sulfate and sodium aluminate, reference may be made in particular to the U.S. Pat. No. 4,154,812.

The silica precursor may be chosen from the group formed by water-soluble alkaline silicates, silicic acid, silicic acid sols, cationic silicon salts, for example hydrated sodium metasilicate, Ludox® in ammoniacal form or alkaline form, quaternary ammonium silicates. The silica sol may be prepared according to any of the methods known to those skilled in the art. Preferably, a decationized orthosilicic acid solution is prepared from a water-soluble alkaline silicate by ion exchange on a resin.

The silicic acid sol may be prepared according to any of the methods known to those skilled in the art. Preferably, the silicic acid sol is prepared from an alkaline silicate in aqueous solution by ion exchange on an ion exchange resin. The content of SiO₂ in the silicic acid sol is between 20 and 120 g/l, preferably between 30 and 90 g/l, and more preferably still between 40 and 80 g/l.

An alumina precursor according to the invention is advantageously dispersed in water contained in a vigorously stirred reactor so as to achieve an alumina Al₂O₃ content of between 4 and 15 g/l, preferably between 5 and 12 g/l and with preference between 6 and 10 g/l of suspension. This suspension is advantageously acidified with nitric acid so as to achieve a pH of between 2 and 6, preferably of between 3 and 5, and then a silica precursor is added at ambient temperature while maintaining vigorous stirring.

The suspension obtained is then advantageously heated to a temperature of between 4° and 95° C., preferentially of between 5° and 70° C., more preferably still of between 55 and 65° C., for to 180 minutes, preferentially 20 to 120 minutes, and more preferably still for 40 to 100 minutes. The suspension is then filtered and the silica-alumina gel obtained contains between 60% and 85% water.

### Step b)

The silica-alumina gel obtained in step a) is then mixed and kneaded, for example in a Brabender kneader, with the zeolite and optionally with a binder, said zeolite having acid site distribution index (ASDI) of greater than 0.15, in order to obtain an extrudable paste.

Said zeolite also has the characteristics described above.

To adjust the solids content of the paste to be extruded so as to make it extrudable, a compound that is predominantly solid, preferably an oxide or a hydrate, may be added. A hydrate will preferably be used, and more preferably still an aluminium hydrate that is a precursor of an aluminic binder.

In the case where the binder is an aluminic binder, the alumina precursor used in step b) may advantageously be identical to or different from the alumina precursor used in step a).

### Step c)

Shaping step c) may be carried out for example by extrusion, by pelletizing, by the drop coagulation (oil-drop) method, by granulation on a rotating plate or by any other method that is well known to those skilled in the art.

Preferably, shaping step c) is carried out by kneading-extrusion.

The extrusion may be carried out with any conventional commercially available tool. The paste resulting from the kneading is extruded through a die, for example using a piston or a single-screw or twin-screw extruder. This extrusion step may be carried out by any method known to those skilled in the art.

The shaping may also be carried out in the presence of the various constituents of the catalyst.

Furthermore, the support employed according to the present invention may have been treated, as is well known to those skilled in the art, with additives in order to facilitate the shaping and/or to improve the final mechanical properties of said support. Mention may in particular be made, as examples of additives, of cellulose, carboxymethylcellulose, carboxyethylcellulose, tall oil, xanthan gums, surface-active agents, flocculating agents, such as polyacrylamides, carbon black, starches, stearic acid, polyacrylic alcohol, polyvinyl alcohol, biopolymers, glucose, polyethylene glycols, and the like.

The support is preferably shaped in the form of grains of various shapes and sizes. It is generally used in the form of twisted multilobal or cylindrical extrudates, but may optionally be manufactured and employed in the form of crushed powder, spheres, lozenges, toruses, beads or wheels. However, it is advantageous for the support to be in the form of extrudates with a diameter of between 0.5 and 5 mm and more particularly of between 0.7 and 3 mm and even more particularly of between 1.0 and 2.5 mm. The shapes are cylindrical (which may or may not be hollow), twisted cylindrical, multilobal (for example 2, 3, 4 or 5 lobes) or toric. The trilobal and quadrilobal forms are preferably used, but any other form may also be used.

### Step d)

The shaped support thus obtained is then dried according to any technique known to those skilled in the art.

The drying step is carried out at a temperature of between 15 and 250° C., preferably of between 3° and 200° C. and more preferably still of between 5° and 180° C., for a duration typically of between 10 minutes and 24 hours. Longer treatment durations are not ruled out but do not contribute an improvement. The drying step is advantageously carried out under an inert atmosphere or under an oxygen-containing atmosphere, at atmospheric pressure or at reduced pressure. Preferably, this drying step is carried out at atmospheric pressure and in the presence of air.

### Step e)

The dried support then undergoes at least one step of heat and/or hydrothermal treatment, according to any technique known to those skilled in the art. Hydrothermal treatment is understood to mean the contacting with water in the vapour phase or in the liquid phase. This treatment may be performed for example in a traversed bed, in a swept bed or in a static atmosphere. For example, the oven used may be a rotary oven or a vertical oven with radial traversed layers.

The heat and/or hydrothermal treatment is carried out at a temperature of between 25° and 1100° C., for a duration typically of between 15 minutes and 10 hours, under an inert atmosphere or under an oxygen-containing atmosphere, optionally in the presence of water. Longer treatment durations are not ruled out but do not contribute an improvement. Several combined cycles of heat or hydrothermal treatments can be carried out.

According to a preferred embodiment of the invention, the dried material undergoes at least one hydrothermal treatment, in the presence of air and of steam, at a temperature of between 600 and 1100° C., preferably of between 65° and 950° C., and more preferably still of between 75° and 900° C., for a duration of between 30 minutes and 5 hours. The steam content is between 20 and 1000 g of water per kg of dry air, preferably between 40 and 500 g of water per kg of dry air and with preference between 100 and 350 g of water per kg of dry air.

According to another preferred embodiment of the invention, the dried material undergoes a heat treatment at a temperature of between 25° and 700° C., preferably of between 30° and 600° C., and more preferably still of between 35° and 550° C., for a duration of between 30 minutes and 5 hours, and then the support thus heat treated then undergoes a hydrothermal treatment, in the presence of air and of steam, at a temperature of between 60° and 1100° C., preferably of between 65° and 950° C., and more preferably still of between 75° and 900° C., for a duration of between 30 minutes and 5 hours. The steam content is between 20 and 1000 g of water per kg of dry air, preferably between 40 and 500 g of water per kg of dry air and with preference between 100 and 350 g of water per kg of dry air.

### Step f)

The support obtained in step e) is then subjected to a step f) of introducing onto said support at least one hydro/dehydrogenating element chosen from the group formed by the elements from group VIB and from group VIII of the periodic table.

The step of introducing at least one hydro/dehydrogenating element is advantageously carried out by any method well known to those skilled in the art, in particular by one or more operations of impregnating the support resulting from step e) with a solution containing precursors of the elements from groups VIB and/or VIII, optionally the precursor of at least one doping element chosen from the group formed by phosphorus, boron and silicon, and optionally the precursor of at least one element from group VIIB and/or from group VB.

Preferably, said step f) is carried out by a method of dry impregnation with a solution containing the precursors of the elements considered.

According to a first embodiment, said precursors of the elements from group VIB and/or from group VIII, optionally the precursors of the doping elements, and optionally the precursors of the elements from group VIIB and from group VB are deposited on said support by one or more co-impregnation steps, that is to say that said precursors are introduced simultaneously onto said support. The co-impregnation step(s) are preferentially performed by dry impregnation or by impregnation in an excess of solution. When this first embodiment comprises the implementation of several co-impregnation steps, each co-impregnation step is preferably followed by an intermediate drying step generally at a temperature of less than 200° C., advantageously of between 5° and 180° C., preferably of between 6° and 150° C., very preferably of between 75 and 140° C.

According to a preferred embodiment by co-impregnation, the impregnation solution is preferably an aqueous solution. Preferably, said aqueous impregnation solution is prepared under pH conditions which promote the formation of heteropolyanions in solution. For example, the pH of said aqueous impregnation solution is between 1 and 5.

According to a second embodiment, the precursors of the element(s) from group VIB, of the element(s) from group VIII, optionally of the doping element(s) and optionally of the element(s) from group VIIB and from group VB are introduced onto the support resulting from step e) by successive depositions in any order. The depositions may be carried out by dry impregnation, by excess impregnation or else by deposition/precipitation, according to methods well known to those skilled in the art. In this second embodiment, an intermediate drying step may be implemented between two successive impregnations, generally at a temperature of less than 200° C., advantageously of between 5° and 180° C., preferably of between 6° and 150° C., very preferably of between 75 and 140° C.

Irrespective of the manner of deposition of said precursors, the solvent used in the composition of the impregnation solutions is chosen so as to dissolve said precursors, such as water or an organic solvent (for example an alcohol).

In a third embodiment, the solution of the precursors of the metal(s) chosen from the elements from group VIB, the elements from group VIII, optionally phosphorus and optionally of the element(s) from group VIIB and from group VB is added in the course of step b). The co-kneading advantageously takes place in a kneader, for example a kneader of “Brabender” type well known to those skilled in the art.

The precursors of the elements from group VIB that may be used are well known to those skilled in the art.

Use may be made, by way of example, among the sources of molybdenum, of the oxides and hydroxides, molybdic acids and salts thereof, in particular the ammonium salts, such as ammonium molybdate, ammonium heptamolybdate, phosphomolybdic acid (H₃PMO₁₂O₄₀), and salts thereof, and optionally silicomolybdic acid (H₄SiMo₁₂O₄₀) and salts thereof. The sources of molybdenum can also be any heteropolycompound of Keggin, lacunary Keggin, substituted Keggin, Dawson, Anderson or Strandberg type, for example. Use is preferably made of molybdenum trioxide and the heteropolycompounds of Keggin, lacunary Keggin, substituted Keggin and Strandberg type.

For example, use may be made, among the sources of tungsten, of the oxides and hydroxides, tungstic acids and salts thereof, in particular the ammonium salts, such as ammonium tungstate, ammonium metatungstate, phosphotungstic acid and salts thereof, and optionally silicotungstic acid (H₄SiW1₂O₄₀) and salts thereof. The sources of tungsten can also be any heteropolycompound of Keggin, lacunary Keggin, substituted Keggin or Dawson type, for example. Use is preferably made of the oxides and the ammonium salts, such as ammonium metatungstate, or the heteropolycompounds of Keggin, lacunary Keggin or substituted Keggin type.

The precursors of the elements from group VIII that may be used are also well known to those skilled in the art. They are advantageously chosen from the oxides, hydroxides, hydroxycarbonates, carbonates, carboxylates (such as for example acetates), nitrates, sulfates, phosphates and halides (such as for example chlorides, bromides and fluorides) of the elements from group VIII. For example, nickel hydroxide, nickel hydroxycarbonate or nickel nitrate, cobalt carbonate or cobalt hydroxide are used with preference.

In the case where a doping element chosen from phosphorus, boron or silicon is present, the preferred source of phosphorus is orthophosphoric acid H₃PO₄, but salts and esters thereof such as ammonium phosphates are also suitable. The phosphorus may be introduced, for example, in the form of a mixture of phosphoric acid and a basic organic compound containing nitrogen such as aqueous ammonia, primary and secondary amines, cyclic amines, compounds of the pyridine and quinoline families and compounds of the pyrrole family. The phosphorus may also be introduced at the same time as the element(s) from group VIB in the form of Keggin, lacunary Keggin, substituted Keggin or Strandberg-type heteropolyanions, such as tungstophosphoric acid, for example.

The phosphorus content is adjusted, without this limiting the scope of the invention, so as to form a mixed compound in solution and/or on the support, for example tungsten-phosphorus or molybdenum-phosphorus or molybdenum-tungsten-phosphorus. These mixed compounds may be heteropolyanions, such as Anderson heteropolyanions, for example.

The source of boron may be boric acid, preferably orthoboric acid H₃BO₃, ammonium diborate or pentaborate, boron oxide or boric esters. The boron may be introduced, for example, in the form of a mixture of boric acid, aqueous hydrogen peroxide solution and a basic organic compound containing nitrogen such as aqueous ammonia, primary and secondary amines, cyclic amines, compounds of the pyridine and quinoline families and compounds of the pyrrole family. The boron may be introduced, for example, by a solution of boric acid in a water/alcohol mixture.

Many sources of silicon may be used. Thus, use may be made of ethyl orthosilicate Si(OEt)₄, siloxanes, polysiloxanes, silicones, silicone emulsions, halide silicates such as ammonium fluorosilicate (NH₄)₂SiF₆ or sodium fluorosilicate Na₂SiF₆. Silicomolybdic acid and salts thereof, silicotungstic acid and salts thereof may also advantageously be used. Silicon may be added, for example, by impregnation of ethyl silicate in solution in a water/alcohol mixture. Silicon may be added, for example, by impregnation of a silicon compound of silicone or silicic acid type suspended in water.

In the case where the catalyst according to the invention also comprises at least one element from group VB, the sources of elements from group VB that may be used are well known to those skilled in the art. For example, among the sources of niobium, use may be made of oxides, such as diniobium pentoxide Nb₂O₅, niobic acid Nb₂Os·H₂O, niobium hydroxides and polyoxoniobates, niobium alkoxides of formula Nb(OR1)₃ where R1 is an alkyl radical, niobium oxalate NbO(HC₂O₄)₅, or ammonium niobate. Use is preferably made of niobium oxalate or ammonium niobate.

In the case where the catalyst according to the invention also comprises at least one element from group VIIB, the sources of elements from group VIIB that may be used are well known to those skilled in the art. Use is preferably made of salts of ammonium, nitrates and chlorides.

### Step g)

The impregnated support resulting from step f) is then subjected to a drying step.

Preferably, said drying step is carried out at a temperature of advantageously less than 250° C., preferably of between 15 and 250° C., more preferentially of between 3° and 220° C., more preferentially still of between 5° and 200° C., and even more preferentially of between 7° and 180° C., for a duration typically between 10 minutes and 24 hours. Longer durations are not ruled out but do not necessarily contribute an improvement.

The drying step may be performed by any technique known to those skilled in the art. It is advantageously performed under an inert atmosphere or under an oxygen-containing atmosphere or under a mixture of inert gas and oxygen. It is advantageously performed at atmospheric pressure or at reduced pressure. Preferably, this step is carried out at atmospheric pressure and in the presence of air or nitrogen.

### Step h) (Optional)

The impregnated and dried support, resulting from step g), is then optionally subjected to a step of heat and/or hydrothermal treatment, according to any technique known to those skilled in the art to obtain said catalyst according to the invention. This treatment may be performed for example in a traversed bed, in a swept bed or in a static atmosphere. For example, the oven used may be a rotary oven or a vertical oven with radial traversed layers.

The heat and/or hydrothermal treatment is carried out at a temperature advantageously of between 250° C. and 1000° C., preferably of between 300° C. and 600° C., under an inert atmosphere or under an oxygen-containing atmosphere, optionally in the presence of steam. The duration of this heat treatment is generally between 15 minutes and 10 hours. Longer durations are not ruled out but do not necessarily contribute an improvement. The steam content is advantageously between 0 and 100 g of water per kg of dry air, preferably between 0 and 80 g of water per kg of dry air.

The catalyst according to the invention thus obtained is preferably subjected to a sulfidation treatment for its use in the hydrocracking process according to the invention, making it possible to transform, at least partially, the metallic species into sulfide, prior to its contacting with the feedstock to be treated. The elements from group VIB and from group VIII of the catalyst of the present invention may be present completely or partially in the metallic and/or oxide and/or sulfide form.

This activation treatment by sulfidation is well known to those skilled in the art and can be carried out by any method already described in the literature, either in situ, i.e. in the reactor, or ex situ.

The sulfiding agents are H₂S gas or any other sulfur-containing compound used for the activation of hydrocarbon feedstocks for the purpose of sulfiding the catalyst. Said sulfur-containing compounds are advantageously chosen from alkyl disulfides, such as for example dimethyl disulfide (DMDS), alkyl sulfides, such as for example dimethyl sulfide, n-butyl mercaptan, polysulfide compounds of tert-nonyl polysulfide type, such as for example TPS-37 or TPS-54 sold by Arkema, or any other compound known to those skilled in the art for obtaining good sulfidation of the catalyst. Preferably, the catalyst is sulfided in situ in the presence of a sulfiding agent and of a hydrocarbon feedstock. Very preferably, the catalyst is sulfided in situ in the presence of a hydrocarbon feedstock additivated with dimethyl disulfide, at a temperature of between 15° and 800° C., preferably of between 25° and 600° C.

The invention also relates to a process for hydrocracking and/or hydroconverting hydrocarbon feedstocks using said catalyst according to the invention.

### Hydrocracking Processes

Another subject of the present invention likewise has the subject of a process for hydrocracking at least one hydrocarbon feedstock, preferably in liquid form, of which at least 50% by weight of the compounds have a boiling point greater than 300° C. and less than 650° C., at a temperature of between 200° C. and 480° C., at a total pressure of between 1 MPa and 25 MPa, with a ratio of volume of hydrogen per volume of hydrocarbon feedstock of between 80 and 5000 litres per litre and at an hourly space velocity (HSV) defined by the ratio of the volume flow rate of hydrocarbon feedstock, which is preferably liquid, per the volume of catalyst charged into the reactor of between 0.1 and 50 h 1, in the presence of the catalyst according to the invention.

Preferably, the hydrocracking process according to the invention is performed in the presence of hydrogen at a temperature of between 25° and 480° C., with preference of between 32° and 450° C., very preferably of between 33° and 435° C., under a pressure of between 2 and 25 MPa, with preference of between 3 and 20 MPa, at a space velocity of between 0.1 and 20 h 1, preferably of between 0.1 and 6 h 1, with preference of between 0.2 and 3 h 1, and the amount of hydrogen introduced is such that the litre of hydrogen/litre of hydrocarbon volume ratio is between 100 and 3000 NI/I.

More preferably still, the hydrocracking process according to the invention is performed in the presence of hydrogen, at a temperature of between 30° and 400° C., under a pressure of between 9 and 20 MPa, at a space velocity of between 0.2 and 3 h 1, and the amount of hydrogen introduced is such that the litre of hydrogen/litre of hydrocarbon volume ratio is between 100 and 2000 NI/I.

Advantageously, the catalyst according to the invention is used in the hydrocracking process according to the invention after a pretreatment section containing one or more hydrotreating catalysts which may be any catalyst known to those skilled in the art and which makes it possible to reduce the content of certain contaminants in the feedstock (see below) such as nitrogen, sulfur or metals. The operating conditions (HSV, temperature, pressure, hydrogen flow rate, liquid, reaction configuration, etc.) of this pretreatment section can be diverse and varied in accordance with the knowledge of those skilled in the art.

### Feedstocks

Very varied feedstocks can be treated by the hydrocracking processes according to the invention. The feedstock used in the hydrocracking process according to the invention is a hydrocarbon feedstock of which at least 50% by weight of the compounds have a boiling point greater than 300° C. and less than 650° C., preferably of which at least 60% by weight, with preference of which at least 75% by weight and more preferably of which at least 80% by weight of the compounds have a boiling point greater than 300° C. and less than 650° C.

The feedstock is advantageously chosen from LCOs (Light Cycle Oil, light gas oils resulting from a catalytic cracking unit), atmospheric distillates, vacuum distillates, for example gas oils resulting from the direct distillation of crude oil or from conversion units, such as FCC, coking or visbreaking units, feedstocks originating from units for the extraction of aromatics from lubricant oil bases or resulting from the solvent dewaxing of lubricant oil bases, distillates originating from processes for the fixed-bed or ebullated-bed desulfurization or hydroconversion of ARs (atmospheric residues) and/or VRs (vacuum residues) and/or deasphalted oils, and deasphalted oils, or paraffins resulting from the Fischer-Tropsch process, or else any mixture of the abovementioned feedstocks. Mention may be made of feedstocks of renewable origin (such as vegetable oils, animal fats, oil from the hydrothermal conversion or pyrolysis of lignocellulosic biomass) and also plastic pyrolysis oils, as well as any mixture of these feedstocks among themselves or with the abovementioned hydrocarbon feedstocks. The above list is not limiting. Said feedstocks preferably have a boiling point T5 above 300° C., preferably above 340° C., that is to say that 95% of the compounds present in the feedstock have a boiling point above 300° C., and with preference above 340° C.

The nitrogen content of the feedstocks treated in the processes according to the invention is advantageously greater than 500 ppm by weight, preferably between 500 and 10 000 ppm by weight, more preferably between 700 and 5000 ppm by weight and more preferably still between 1000 and 4000 ppm by weight. The sulfur content of the feedstocks treated in the processes according to the invention is advantageously between 0.01% and 5% by weight, preferably between 0.2% and 4% by weight and more preferably still between 0.5% and 3% by weight.

The feedstock may optionally contain metals. The combined nickel and vanadium content of the feedstocks treated in the processes according to the invention is preferably less than 10 ppm by weight, with preference less than 5 ppm by weight, and more preferably still less than 1 ppm by weight.

The feedstock may optionally contain asphaltenes. The asphaltene content is generally less than 3000 ppm by weight, preferably less than 1000 ppm by weight and more preferably still less than 200 ppm by weight.

Advantageously, when the catalyst according to the invention is used after a hydrotreating section, the contents of nitrogen, sulfur, metals and/or asphaltenes in the liquid injected into the process according to the invention using the catalyst according to the invention are reduced. With preference, the content of organic nitrogen in the feedstock treated in the hydrocracking process according to the invention is then, after hydrotreatment, between 0 and 200 ppm, preferably between 0 and 50 ppm, and more preferably still between 0 and 30 ppm. The sulfur content is preferably less than 1000 ppm, preferably between 5 and 500 ppm and more preferably still between 10 and 400 ppm. The asphaltene content is preferably less than 200 ppm while the content of metals (Ni or V) is less than 1 ppm.

The hydrocracking process according to the invention may comprise a fractionation step between the section for hydrotreating the feedstock and the hydrocracking reactor(s) using the catalyst according to the invention. In one embodiment where the hydrocracking process is carried out without (gas and liquid) fractionation between the hydrotreating section and the hydrocracking reactor(s) using the catalyst according to the invention (“one-step” process), the nitrogen and the sulfur removed from the liquid by the hydrotreatment are injected in the form of NH₃ and H₂S into the reactor(s) containing the catalyst according to the invention. In the preferred case where the hydrocracking process is carried out with (gas and liquid) fractionation between the hydrotreating section and at least one of the hydrocracking reactors using the catalyst according to the invention (“two-step” process), the NH₃ content in the liquid downstream of the fractionation is between 0 and 100 ppm, preferably between 0 and 50 ppm and more preferably still between 0 and 20 ppm, and the H₂S content is between 0 and 1000 ppm, preferably between 5 and 500 ppm and more preferably still between 10 and 400 ppm.

The process can be carried out in one step or two steps, as described below, depending on the degree of conversion of the targeted feedstock, with or without recycling of the unconverted fraction. Preferably, the process is carried out in two steps with recycling of the unconverted fraction. The catalyst according to the invention can be used in a non-limiting manner in at least one of the hydrocracking reactors of the one or two steps of the hydrocracking process, alone or in combination with another hydrocracking catalyst. Preferably, the catalyst according to the invention is used in at least one of the hydrocracking reactors located downstream of the (gas and liquid) fractionation.

These operating conditions used in the processes according to the invention generally make it possible to obtain conversions per pass, into products having boiling points of less than 340° C. and better still of less than 370° C., of greater than 15% by wt. and more preferably still of between 20 and 100% by wt.

In the “one-step” process, the feedstock to be converted passes over a hydrocracking catalyst once. The products obtained are added directly to the petrol, kerosene or diesel pools of the refinery, and the unconverted fraction can serve as a base for oils or can be converted by the FCC process.

In the “two-step” process, an intermediate separation is carried out at the outlet from a first hydrocracking reactor, making it possible to separate the cracked products from the portion not converted in the first reactor. The unconverted fraction of the feedstock is then sent to a second hydrocracking reactor containing a second hydrocracking catalyst in order to increase the total conversion of the feedstock into middle distillates.

The following examples illustrate the present invention without, however, limiting the scope thereof.

### EXAMPLES

### Example 1: Preparation of a Catalyst C1 (in Accordance with the Invention)

### Preparation of a Silica-Alumina Gel SA1

A boehmite gel G1 is prepared according to Example 1 of the patent U.S. Pat. No. 4,154,812 and spray dried, and has the following characteristics:

TABLE 1
Table 1: Characteristics of the boehmite gel G1 prepared
according to the patent U.S. Pat. No. 4,154,812

| | |
|---|---|
| Dispersibility index (%) | 68 |
| Crystallite size along [020] (nm) | 2.9 |
| Crystallite size along [120] (nm) | 4.1 |
| Na content (ppm) | 74 |
| S content (ppm) | 667 |
| Loss on ignition (LOI, % by weight) | 29.8 |

126 g of this boehmite gel are dispersed in 1450 g of water acidified with 3.9 g of 68% nitric acid. The suspension obtained is stirred at ambient temperature using a mechanical stirrer. A litre of a silicic acid sol is prepared by passing a sodium silicate solution, diluted to the concentration required to obtain an amount equivalent to 60 g of SiO₂ in the sol, through an ion exchange resin (acidified beforehand). The silica sol obtained is added to the boehmite suspension using a peristaltic pump at a flow rate of 22 ml/min. The mixture is then heated to 60° C. and then matured at this temperature with stirring for 1 hour. The suspension is then filtered on a sintered Buchner-type device to obtain the silica-alumina gel SA1.

X-ray fluorescence measurement on the silica-alumina gel SA1 indicates a silica content of 32.2% by weight, expressed in % by weight of SiO₂ relative to the total oxide content (SiO₂+Al₂O₃).

This gel SA1 has a loss on ignition of 70.8%.

The loss on ignition corresponds to the water content of the material; it is measured via the loss of mass after a heat treatment at 1000° C. for 4 hours.

### Zeolite Z1

A zeolite Z1 of USY type is used, having the following characteristics:

TABLE 2
Table 2: Characteristics of the zeolite Z1

| | |
|---|---|
| Lattice parameter (×10⁻¹⁰ m) | 24.30 |
| SiO₂/Al₂O₃ molar ratio | 30 |
| Na content (ppm by weight) | 108 |
| BET surface area (m²/g) | 870 |
| N2 Vpore (ml/g) | 0.534 |
| V(<2 nm)/N2 Vpore (%) | 60 |
| V(2-50 nm)/N2 Vpore (%) | 33 |
| V(8-50 nm)/N2 Vpore (%) | 19 |
| V(>50 nm)/N2 Vpore (%) | 7 |
| acidity (pyridine) (micromol/g) | 221 |
| Acid site density (H/D exchange) (mmol/g) | 0.54 |
| ASDI distribution index (—) | 0.22 |
| Loss on ignition (% by weight) | 10 |

### Shaping of the Support S1

218 g of the silica-alumina gel SA1, 4 g of the zeolite Z1 and 11.7 g of the boehmite gel G1 are mixed and kneaded at 50 rpm in a Z-arm kneader, and then the paste obtained is extruded through a trilobe die of 2.5 mm diameter. The amount of zeolite Z1 added corresponds to a content by mass of 5% by weight of Z1 relative to the total weight of the dry support.

### Hydrothermal Treatment of the Support S1

After drying for 20 hours at 80° C. in a ventilated oven, the extrudates are treated hydrothermally at 450° C. for 2 hours under a stream of air containing less than 40 g of water per kilogram of dry air, and then at 800° C. for 2 hours in the presence of steam with 200 g of water per kilogram of dry air.

The characteristics of the support S1 thus obtained are collated in Table 7 below.

Preparation of the Catalyst C1 (in Accordance with the Invention)

The catalyst C1 is obtained by dry impregnation of the support S1 with an aqueous solution containing tungsten and nickel salts. The tungsten salt is ammonium metatungstate (NH₄)₆H₂W₁₂O₄₀·4H₂O and the nickel salt is nickel nitrate Ni(NO₃)₂·6H₂O. After maturation at ambient temperature in a water-saturated atmosphere for 10 hours, the impregnated extrudates are dried at 120° C. for 18 hours in a ventilated oven and then treated hydrothermally at 500° C. for 2 hours under a stream of air containing less than 40 g of water per kilogram of dry air.

The characteristics of the catalyst C1 thus obtained are collated in Table 8 below.

### Example 2: Preparation of a Catalyst C2 (Comparative)

The support S2 of the catalyst C2, not in accordance with the invention, is prepared using a commercial PURAL® SB3 boehmite gel having the following characteristics:

TABLE 3
Table 3: Characteristics of the commercial
PURAL ® SB3 boehmite gel

| | |
|---|---|
| Dispersibility index (%) | 98 |
| Crystallite size along [020] (nm) | 3.1 |
| Crystallite size along [120] (nm) | 4.7 |
| Na content (ppm) | <detection limit |
| S content (ppm) | <detection limit |
| Loss on ignition (% by weight) | 23 |

115 g of the commercial PURAL® SB3 boehmite gel are dispersed in 1450 g of water acidified with 3.9 g of 68% nitric acid. The suspension obtained is stirred at ambient temperature using a mechanical stirrer. A litre of a silicic acid sol is prepared by passing a sodium silicate solution, diluted to the concentration required to obtain an amount equivalent to 60 g of SiO₂ in the sol, through an ion exchange resin (acidified beforehand). The silica sol obtained is added to the boehmite suspension using a peristaltic pump at a flow rate of 22 ml/min. The mixture is then heated to 60° C. and then matured at this temperature with stirring for 1 hour. The suspension is then filtered on a sintered Buchner-type device to obtain the silica-alumina gel SA2.

X-ray fluorescence measurement on the silica-alumina gel SA2 indicates a silica content of 32.0% by weight, expressed in % by weight of SiO₂ relative to the total oxide content (SiO₂+Al₂O₃).

The loss on ignition of the gel SA2 is 74.5%.

### Shaping of the Support S2

247 g of the silica-alumina gel SA2, 4 g of the zeolite Z1 used above and 11.6 g of boehmite are then kneaded at 50 rpm in a Z-arm kneader, and then the paste obtained is extruded through a trilobe die of 2.5 mm diameter. The amount of zeolite Z1 added corresponds to a content by mass of 5% by weight of Z1 relative to the total weight of the dry support.

### Hydrothermal Treatment of the Support S2

After drying for 20 hours at 80° C. in a ventilated oven, the extrudates are treated hydrothermally at 450° C. for 2 hours under a stream of air containing less than 40 g of water per kilogram of dry air, and then at 800° C. for 2 hours in the presence of steam with 200 g of water per kilogram of dry air.

The characteristics of the support S2 thus obtained are collated in Table 7 below.

### Preparation of the Catalyst C2 (Comparative)

The catalyst C2 is obtained by dry impregnation of the support S2 according to the same protocol as that described for the preparation of the catalyst C1. The physicochemical properties of the catalyst C2 thus obtained are collated in Table 8 below.

### Example 3: Preparation and Shaping of a Catalyst C3 (Comparative)

### Preparation of a Silica-Alumina Gel SA3

A boehmite gel G3 is prepared according to Example 1 of the patent U.S. Pat. No. 6,589,908 and spray dried, and has the following characteristics:

TABLE 4
Table 4: Characteristics of the boehmite gel G3 prepared
according to the patent U.S. Pat. No. 6,589,908

| | |
|---|---|
| Dispersibility index (%) | 75 |
| Crystallite size along [020] (nm) | 3.5 |
| Crystallite size along [120] (nm) | 4.3 |
| Na content (ppm) | 53 |
| S content (ppm) | 429 |
| Loss on ignition (% by weight) | 25.6 |

119 g of this boehmite gel are dispersed in 1450 g of water acidified with 3.9 g of 68% nitric acid. The suspension obtained is stirred at ambient temperature using a mechanical stirrer. A litre of a silicic acid sol is prepared by passing a sodium silicate solution, diluted to the concentration required to obtain an amount equivalent to 60 g of SiO₂ in the sol, through an ion exchange resin (acidified beforehand). The silica sol obtained is added to the boehmite suspension using a peristaltic pump at a flow rate of 22 ml/min. The mixture is then heated to 60° C. and then matured at this temperature with stirring for 1 hour. The suspension is then filtered on a sintered Buchner-type device to obtain the silica-alumina gel SA3.

X-ray fluorescence measurement on the silica-alumina gel SA3 indicates a silica content of 33.2% by weight, expressed in % by weight of SiO₂ relative to the total oxide content (SiO₂+Al₂O₃).

The loss on ignition of SA3 is 72%.

### Shaping of the Support S3

226 g of the silica-alumina gel SA3, 4 g of the zeolite Z1 used above and 11.7 g of boehmite are then kneaded at 50 rpm in a Z-arm kneader, and then the paste obtained is extruded through a trilobe die of 2.5 mm diameter. The amount of zeolite Z1 added corresponds to a content by mass of 5% by weight of Z1 relative to the total weight of the dry support.

### Hydrothermal Treatment of the Support S3

After drying for 20 hours at 80° C. in a ventilated oven, the extrudates are treated hydrothermally at 450° C. for 2 hours under a stream of air containing less than 40 g of water per kilogram of dry air, and then at 800° C. for 2 hours in the presence of steam with 200 g of water per kilogram of dry air.

The characteristics of the support S3 thus obtained are collated in Table 7 below.

### Preparation of the Catalyst C3 (Comparative)

The catalyst C3 is obtained by dry impregnation of the support S3 according to the same protocol as that described for the preparation of the catalyst C1. The physicochemical properties of the catalyst C3 thus obtained are collated in Table 8 below.

### Example 4: Preparation and Shaping of a Catalyst C4 (Comparative)

The boehmite gel G1 described in Example 1 is heated to 110° C. for 1 hour in an autoclave to obtain a gel G4 after filtration having different characteristics from the gel G1, these characteristics being presented below:

TABLE 5
Table 5: Characteristics of the boehmite gel G4

| | |
|---|---|
| Dispersibility index (%) | 12 |
| Crystallite size along [020] (nm) | 3.2 |
| Crystallite size along [120] (nm) | 4.5 |
| Na content (ppm) | 95 |
| S content (ppm) | 568 |
| Loss on ignition (% by weight) | 76 |

369 g of boehmite gel G4 are dispersed in 1200 g of water acidified with 3.9 g of 68% nitric acid. The suspension obtained is stirred at ambient temperature using a mechanical stirrer. A litre of a silicic acid sol is prepared by passing a sodium silicate solution, diluted to the concentration required to obtain an amount equivalent to 60 g of SiO₂ in the sol, through an ion exchange resin (acidified beforehand). The silica sol obtained is added to the boehmite suspension using a peristaltic pump at a flow rate of 22 ml/min. The mixture is then heated to 60° C. and then matured at this temperature with stirring for 1 hour. The suspension is then filtered on a sintered Buchner-type device to obtain the silica-alumina gel SA4.

X-ray fluorescence measurement on the silica-alumina gel SA4 indicates a silica content of 32.8% by weight, expressed in % by weight of SiO₂ relative to the total oxide content (SiO₂+Al₂O₃).

### Shaping of the Support S4

264 g of the silica-alumina gel SA4 (LOI=73.8%), 4 g of the zeolite Z1 used above and 11.6 g of boehmite are mixed and kneaded at 50 rpm in a Z-arm kneader, and then the paste obtained is extruded through a trilobe die of 2.5 mm diameter. The amount of zeolite Z1 added corresponds to a content by mass of 5% by weight of Z1 relative to the total weight of the dry support.

### Hydrothermal Treatment of the Support S4

After drying for 20 hours at 80° C. in a ventilated oven, the extrudates are treated hydrothermally at 450° C. for 2 hours under a stream of air containing less than 40 g of water per kilogram of dry air, and then at 800° C. for 2 hours in the presence of steam with 200 g of water per kilogram of dry air.

The characteristics of the support S4 thus obtained are collated in Table 7 below.

### Preparation of the Catalyst C4 (Comparative)

The catalyst C4 is obtained by dry impregnation of the support S4 according to the same protocol as that described for the preparation of the catalyst C1. The physicochemical properties of the catalyst C4 thus obtained are collated in Table 8 below.

### Example 5: Preparation and Shaping of a Catalyst C5

### Zeolite Z5

A zeolite Z5 of USY type is used, having the following characteristics:

TABLE 6
Table 6: Characteristics of the zeolite Z5

| | |
|---|---|
| Lattice parameter (×10⁻¹⁰ m) | 24.23 |
| SiO₂/Al₂O₃ molar ratio | 85 |
| Na content (ppm by weight) | 66 |
| BET surface area (m²/g) | 900 |
| N2 Vpore (ml/g) | 0.553 |
| V(<2 nm)/N2 Vpore (%) | 56 |
| V(2-50 nm)/N2 Vpore (%) | 38 |
| V(8-50 nm)/N2 Vpore (%) | 17 |
| V(>50 nm)/N2 Vpore (%) | 6 |
| acidity (pyridine) (micromol/g) | 88 |
| Acid site density (H/D exchange) (mmol/g) | 0.13 |
| ASDI distribution index (—) | 0.08 |
| Loss on ignition | 12 |

### Shaping of the Support S5

207 g of the silica-alumina gel SA1 used in Example 1, 3.9 g of the zeolite Z5 and 11.7 g of boehmite are then kneaded at 50 rpm in a Z-arm kneader, and then the paste obtained is extruded through a trilobe die of 2.5 mm diameter. The amount of zeolite Z5 added corresponds to a content by mass of 5% by weight of Z5 relative to the total weight of the dry support.

### Hydrothermal Treatment of the Support S5

After drying for 20 hours at 80° C. in a ventilated oven, the extrudates are treated hydrothermally at 450° C. for 2 hours under a stream of air containing less than 40 g of water per kilogram of dry air, and then at 800° C. for 2 hours in the presence of steam with 200 g of water per kilogram of dry air.

The characteristics of the support S5 thus obtained are collated in Table 7 below.

### Preparation of the Catalyst C5 (Comparative)

The catalyst C5 is obtained by dry impregnation of the support S5 according to the same protocol as that described for the preparation of the catalyst C1. The physicochemical properties of the catalyst C5 thus obtained are collated in Table 8 below.

The characteristics of the different supports S1 to S5 and of the different catalysts C1 to C5 are listed in the table below:

TABLE 7
Table 7: Characteristics of the supports S1 to S5

| | S1 | | | | |
|---|---|---|---|---|---|
| | (according | | | | |
| | to the | S2 | S3 | S4 | |
| | invention) | (comparative) | (comparative) | (comparative) | S5 |
| Silica-alumina gel | SA1 | SA2 | SA3 | SA4 | SA1 |
| Zeolite | Z1 | Z1 | Z1 | Z1 | Z5 |
| Content of zeolite | 5 | 5 | 5 | 5 | 5 |
| in the dry support | | | | | |
| (% by weight) | | | | | |
| Content of silica- | 89 | 89 | 89 | 89 | 89 |
| alumina gel in the | | | | | |
| dry support (% by | | | | | |
| wt.) | | | | | |
| SBET (m²/g) | 281 | 288 | 300 | 294 | 282 |
| N2 Vpore (ml/g) | 0.68 | 0.53 | 0.75 | 0.67 | 0.68 |
| V(<2 nm)/N2 | 2 | 3 | 2 | 2 | 2 |
| Vpore (%) | | | | | |
| V(2-50 nm)/N2 | 97 | 96 | 98 | 96 | 97 |
| Vpore (%) | | | | | |
| V (6-11 nm) (N2) | 0.21 | 0.28 | 0.20 | 0.53 | 0.22 |
| (ml/g) | | | | | |
| Hg Vpore (ml/g) | 0.61 | 0.45 | 0.67 | 0.58 | 0.61 |
| V(>14 nm) (Hg) | 0.19 | 0.03 | 0.28 | 0.02 | 0.20 |
| (ml/g) | | | | | |
| V(>16 nm) (Hg) | 0.15 | 0.02 | 0.24 | 0.01 | 0.15 |
| (ml/g) | | | | | |
| V(>20 nm) (Hg) | 0.08 | 0.02 | 0.13 | 0.01 | 0.08 |
| (ml/g) | | | | | |
| V(>50 nm) (Hg) | 0.003 | 0.02 | 0.01 | 0.01 | 0.003 |
| (ml/g) | | | | | |
| Hg pore | 1 very | Monomodal | 1 very broad | 1 very broad | 1 very broad |
| distribution | broad peak | distribution | peak | peak | peak |
| | between 3 | | between 3 | between 3 | between 3 |
| | and 45 nm | | and 45 nm | and 45 nm | and 45 nm |
| Mean D (Hg) (nm) | 11.5 | 6.7 | 12.1 | 11.7 | 11.5 |
| V2/Hg Vpore (—) | 0.38 | 0.95 | 0.29 | 0.90 | 0.38 |
| V3 (ml/g) | 0.20 | 0.04 | 0.25 | 0.02 | 0.20 |
| V5/V2 (—) | 0.49 | 0.92 | 0.54 | 0.81 | 0.49 |
| V6 (ml/g) | 0.25 | 0.07 | 0.28 | 0.03 | 0.25 |
| TPD (g/ml) | 0.57 | 0.68 | 0.47 | 0.61 | 0.58 |
| Grain density | 0.96 | 1.05 | 0.82 | 1.01 | 0.96 |
| (g/ml) | | | | | |

TABLE 8
Table 8: Characteristics of the catalysts C1 to C5

| | C1 | | | | |
|---|---|---|---|---|---|
| | (according | | | | |
| | to the | C2 | C3 | C4 | |
| | invention) | (comparative) | (comparative) | (comparative) | C5 |
| WO₃ (% by wt.) | 24.7 | 24.7 | 24.7 | 24.7 | 24.7 |
| NiO (% by wt.) | 3.4 | 3.4 | 3.4 | 3.4 | 3.4 |
| TPD (g/ml) | 0.81 | 0.97 | 0.67 | 0.87 | 0.83 |
| SBET (m²/g) | 202 | 207 | 216 | 211 | 202 |
| N2 Vpore (ml/g) | 0.47 | 0.31 | 0.52 | 0.46 | 0.47 |
| Hg Vpore (ml/g) | 0.42 | 0.25 | 0.48 | 0.38 | 0.42 |
| Hg pore | 1 very | Monomodal | 1 very | 1 very | 1 very |
| distribution | broad peak | distribution | broad peak | broad peak | broad peak |
| | between 3 | | between 3 | between 3 | between 3 |
| | and 40 nm | | and 40 nm | and 40 nm | and 40 nm |
| Mean D (Hg) | 11.0 | 6.6 | 12.1 | 11.5 | 11.0 |
| (nm) | | | | | |
| V2/Hg Vpore (—) | 0.35 | 0.91 | 0.25 | 0.84 | 0.34 |
| V3 (ml/g) | 0.15 | 0.03 | 0.18 | 0.02 | 0.15 |
| V5/V2 (—) | 0.48 | 0.90 | 0.53 | 0.81 | 0.48 |
| V6 (ml/g) | 0.18 | 0.07 | 0.20 | 0.02 | 0.18 |
| V(>14 nm) (Hg) | 0.17 | 0.02 | 0.24 | 0.01 | 0.17 |
| (ml/g) | | | | | |
| V(>16 nm) (Hg) | 0.13 | 0.01 | 0.22 | 0.01 | 0.13 |
| (ml/g) | | | | | |
| V(>20 nm) (Hg) | 0.07 | 0.01 | 0.12 | 0.005 | 0.07 |
| (ml/g) | | | | | |
| V(>50 nm) (Hg) | 0.002 | 0.009 | 0.01 | 0.002 | 0.002 |
| (ml/g) | | | | | |
| V(>50 nm)/Hg | 0.5 | 4 | 2 | 0.5 | 0.5 |
| Vpore (%) | | | | | |
| V (8-20 nm)/Hg | 62 | 13 | 64 | 9 | 62 |
| Vpore (%) | | | | | |
| V (20-50 nm)/ | 16 | 0.5 | 23 | 1 | 16 |
| Hg Vpore (%) | | | | | |

### Example 6: Evaluation of the Catalysts C1 to C5 in the One-Step Hydrocracking of a Vacuum Distillate

Catalysts C1 to C5, the preparation of which is described in Examples 1 to 5, are used to carry out the hydrocracking of a vacuum distillate that had been hydrotreated beforehand and the main characteristics of which are given below:

TABLE 9
Table 9: Characteristics of the vacuum distillate
that had been hydrotreated beforehand

| | |
|---|---|
| Density (20/4) | 0.8821 |
| Sulfur (ppm by weight) | 21 |
| Nitrogen (ppm by weight) | 3.4 |

Simulated distillation

| | |
|---|---|
| Starting point | 134° C. |
| 5% point | 261° C. |
| 10% point | 321° C. |
| 50% point | 447° C. |
| 90% point | 540° C. |
| Final point | 606° C. |

Catalysts C1 to C5 are used according to the process of the invention by employing an isothermal test pilot unit comprising a fixed-bed reactor with up-flow of the feedstock. The test feedstock is additivated respectively with dimethyl disulfide (DMDS) and with aniline so as to obtain 2.8% by weight of sulfur and 1250 ppm by weight of nitrogen in the additivated feedstock, in order to simulate the partial pressure of hydrogen sulfide and of ammonia generated by the hydrotreatment step of the process.

Each catalyst is evaluated separately and is sulfided prior to the hydrocracking test using a straight-run gas oil additivated with 4% by weight of dimethyl disulfide (DMDS) and 2% by weight of aniline. The sulfidation is carried out at an HSV of 2 h¹ (HSV=Hourly Space Velocity), an H₂/feedstock volume ratio of 1000 NI/I, a total pressure of 14 MPa and a temperature of 350° C. for 6 hours.

After sulfidation, the operating conditions are adjusted to those used for the hydrocracking test: an HSV of 1.5 h⁻¹, an H₂/feedstock volume ratio of 1000 NI/I, a total pressure of 14 MPa. The temperature of the reactor is adjusted so as to target a net conversion of the 370° C.+ fraction of 70% by weight after 150 hours with feedstock.

The catalytic performance qualities are expressed by the net conversion to products having a boiling point of less than 370° C. (NC_370-) and by the gross selectivity for middle distillates (150-370° C. cut) (GS_MD). They are expressed on the basis of the simulated distillation results.

The net conversion NC to products having a boiling point of less than 370° C. (NC_370-) is defined by:

$$NC\_ 370 -= [ \text{} ( \%370 - effluents ) - ( \%370 -- feedstock ) ] / [ \text{} 100 - ( \%370 -- feedstock ) ]$$

where % 370_effluents is the content by mass of compounds having boiling points of less than 370° C. in the effluents,
and % 370-feedstock is the content by mass of compounds having boiling points of less than 370° C. in the feedstock.

The gross selectivity for middle distillates (GS_MD) is defined by:

$$GS\_MD = ( \%150 - 370 effluents ) / ( \%370 - effluents )$$

where % 150-370 effluents is the content by mass of compounds having boiling points of between 150° C. and 370° C. in the effluents.

The catalytic performance qualities obtained are given in Table 10 below.

TABLE 10
Table 10: Catalytic results of one-step hydrocracking

| Cata- | | |
|---|---|---|
| lyst | T to achieve NC_370− = 70% | GS_MD at NC_370− = 70% |
| C1 | 402° C. | 56% |
| C2 | 406° C. | 54% |
| C3 | 410° C. | 52% |
| C4 | 405° C. | 47% |
| C5 | 415° C. | 56% |

Example 6 thus shows the full advantage of using catalyst C1 according to the invention for carrying out hydrocracking of hydrocarbon feedstocks. Specifically, it makes it possible to obtain a net conversion to products having a boiling point of less than 370° C. (NC_370) of 70% at a lower temperature than the catalysts C2, C3, C4 and C5, while retaining a high gross selectivity for middle distillates (GS_MD).

1. Catalyst comprising at least one hydro/dehydrogenating element chosen from the group formed by the elements from group VIB and from group VIII of the periodic table, alone or as a mixture, and a support comprising at least one zeolite and one amorphous silica-alumina, wherein the support has:
a pore volume, measured by nitrogen porosimetry, developed within the pores with a diameter of between 6 nm and 11 nm, of less than 0.5 ml/g,
a grain density, measured by mercury displacement under a pressure of 0.003 MPa, of greater than 0.93 g/ml,
a tapped packing density (TPD) of greater than 0.5 g/ml and less than 0.65 g/ml.

2. Catalyst according to claim 1, wherein the content in the catalyst of element from group VIII is between 0.03% and 15% by weight of oxide relative to the total weight of said catalyst, preferably between 0.5% and 10% by weight of oxide and very preferably between 1.0% and 8% by weight of oxide, and the content in the catalyst of element from group VIB is between 1% and 50% by weight of oxide relative to the total weight of said catalyst, preferably between 5% and 40% by weight of oxide, and more preferably still between 10% and 35% by weight of oxide.

3. Catalyst according to claim 1, wherein the element from group VIII is nickel and the element from group VIB is tungsten.

4. Catalyst according to claim 1, wherein the zeolite is chosen from Y, USY, VUSY, SDUSY, mordenite, beta, EU-1, EU-2, EU-11, Nu-87, ZSM-48 or ZBM-30 zeolites.

5. Catalyst according to claim 4, wherein the zeolite is chosen from Y, ultrastable Y(USY), very ultrastable Y(VUSY) or dealuminated ultrastable Y(SDUSY) zeolites.

6. Catalyst according to claim 1, wherein the zeolite has an acid site distribution index (ASDI) determined by H/D exchange of greater than 0.15.

7. Catalyst according to claim 1, wherein the zeolite has a volume developed within the pores with a diameter of greater than 50 nm, and measured by nitrogen physisorption, which represents less than 15% and preferably less than 10% of the total pore volume.

8. Catalyst according to claim 1, wherein the support has a pore volume, measured by nitrogen physisorption, contained within the pores with a diameter of greater than 6 nm and less than 11 nm, of between 0.05 and 0.45 ml/g and preferably of between 0.1 and 0.35 ml/g.

9. Catalyst according to claim 1, wherein the support also comprises a binder consisting of at least one refractory oxide chosen from the group formed by alumina, silica-alumina, clay, titanium oxide, boron oxide and zirconia, taken alone or as a mixture; and preferably the binder is alumina.

10. Catalyst according to claim 1, wherein the content by weight of silica-alumina in the catalyst is generally between 1% and 99% relative to the total weight of said catalyst, advantageously between 10% and 85% by weight, and preferably between 40% and 75% by weight.

11. Catalyst according to claim 1, wherein the content by weight of zeolite in the catalyst is generally between 0.1% and 30% relative to the total weight of said catalyst, advantageously between 0.2% and 20% by weight, preferably between 0.5% and 10% by weight, more preferably between 1% and 9% by weight and more preferably still between 1.5% and 8% by weight.

12. Process for preparing the catalyst according to claim 1, comprising at least the following steps:
a) a step of preparing a silica-alumina gel by mixing a silica precursor with an alumina precursor, said alumina precursor having:
a dispersibility index of between 15% and 70%,
a sodium content of between 0.003% and 2% by weight, relative to the total mass of the alumina precursor,
a sulfur content of between 0.005% and 2% by weight, relative to the total mass of the alumina precursor,
b) a step of mixing at least one zeolite with the silica-alumina gel resulting from step a), said zeolite having an acid site distribution index (ASDI) measured by H/D exchange of greater than 0.15,
c) a step of shaping, optionally in the presence of an aluminic binder, of the mixture obtained,
d) at least one step of drying the shaped material,
e) at least one step of heat and/or hydrothermal treatment of the dried material to obtain the support,
f) a step of introducing onto the support at least one hydro/dehydrogenating element chosen from the group formed by the elements from group VIB of the periodic table and the non-noble elements from group VIII of the periodic table,
g) at least one step of drying the impregnated support,
e) and optionally at least one step of heat and/or hydrothermal treatment of the impregnated and dried support to obtain said catalyst.

13. Process for hydrocracking at least one hydrocarbon feedstock, preferably in liquid form, of which at least 50% by weight of the compounds have a boiling point greater than 300° C. and less than 650° C., at a temperature of between 200° C. and 480° C., at a total pressure of between 1 MPa and 25 MPa, with a ratio of volume of hydrogen per volume of hydrocarbon feedstock of between 80 and 5000 litres per litre and at an hourly space velocity (HSV) defined by the ratio of the volume flow rate of hydrocarbon feedstock, which is preferably liquid, per the volume of catalyst charged into the reactor of between 0.1 and 50 h⁻¹, in the presence of the catalyst according to claim 1.
